(19) United States
(12) Patent Application Publication
(10) Pub. No.: US 2025/0334049 A1
(43) Pub. Date: Oct. 30, 2025

(54) METHOD TO MEASURE FRACTURE WIDTH

(71) Applicant: Quidnet Energy, Inc., Houston, TX (US)

(72) Inventor: Bunker Hill, Sugar Land, TX (US)

(21) Appl. No.: 19/174,598

(22) Filed: Apr. 9, 2025

Related U.S. Application Data
(60) Provisional application No. 63/640,046, filed on Apr. 29, 2024.

(51) Int. Cl. E21B 49/00; E21B 43/26; G01B 7/02; G01B 11/02; G01D 5/22

(52) U.S. Cl. CPC E21B 49/00; G01B 7/02; G01B 11/02; G01D 5/2291; E21B 43/26

(57) ABSTRACT

The present invention explains methods for measuring the width of a fracture created in a subterranean zone and the completion that houses the width measurement device. This equipment is intended to be used in a geomechanical energy storage system which will be used to produce electricity.

### CROSS-REFERENCE TO RELATED APPLICATION

This application claims the benefit of U.S. Provisional Patent Application No. 63/640,046 filed Apr. 29, 2024, which is hereby incorporated by reference in its entirety herein.

### GOVERNMENT RIGHTS

This technology was made with government support from DOE under ARPA-E, Award No. DE-AR0001680. The U.S. Government has certain rights in this technology.

### BACKGROUND OF THE INVENTION

### I. Field of the Invention

The present disclosure relates generally to devices and measurement methods in a downhole well bore between two points that move relative to one another during the fracture treatment, fluid injection, and fluid withdrawal from a subterranean zone. These measurement methods more particularly relate to measuring the width of a subterranean zone fracture by measuring the distance between two points on opposite sides of the fracture.

### II. Description of the Prior Art

Energy storage is needed to balance the large variations in supply and demand to supplement the power generation systems currently in use. High summer temperatures, low winter temperatures, electric powered transportation methods, artificial intelligence (AI) data methods and the like are adding to the power needs of today. Large scale energy storage methods currently include compressed air energy storage (CAES), natural gas cavern storage, pumped hydro, chemical batteries, and subterranean energy storage. Each energy storage system uses different physics and mechanics to achieve the goal of providing energy when it is needed in sufficient quantity. Underground, cavern, and natural gas storage is popular in Europe and other places around the world to store chemical energy until it is needed in the long heating season.

Pumped hydro is the method of storing energy by pumping water to a higher elevation, storing it, then later allowing the water to fall under gravitational forces to spin a turbine/generator combination to produce electricity. Water is pumped up the hill during off-peak demand periods when electricity is available at a lower cost. For pumped hydro, (potential energy)=mass of water (m)×gravitational acceleration (g)×height difference (h).

Subterranean energy storage is similar to compressed air energy storage (CAES) in that the working fluid is stored underground, however the energy recovery mechanisms are quite different. Both systems can gain some geothermal energy from the earth to warm the working fluid but subterranean energy storage relies on the elasticity of the earth and the overburden on the rock where the working fluid is stored.

In the construction phase of the subterranean energy storage system the well, the subterranean zone, and the surface facilities must be built and/or properly prepared for the operation phase. A subterranean zone can be made up of man-made hydraulic fractures, natural fractures, natural occurring caves, or other fluidically connected geologic features. Not all subterranean systems include fractured formations in the subterranean zone. Some are well sealed and do not require hydraulic fracturing or sealing.

For this technology any or all fluidically connected parts can be used to store high pressure fluid. The fluid stored may be used as the working fluid for a system to produce electricity or other useful work below ground or above ground.

The steps to prepare the zone, fracture, and store high pressure fluid in the subterranean zone, and then move it to the surface equipment to perform useful work, desalinate water and generate electricity are described in applicant's earlier granted patents, U.S. Pat. Nos. 8,763,387, 9,481,519, 10,125,035 and 11,927,085, all of which are hereby incorporated by reference in their entirety herein. Also hereby incorporated in their entirety herein are applicants' U.S. Pat. No. 11,795,802 describing the creation of fractures in the subterranean zone, sealing it, and preparing it to store high-pressure working fluids which are later moved to the surface to perform useful work; and U.S. Pat. No. 12,123,293 describing other methods to fracture and seal the subterranean zone prior to utilizing it for storage of the high-pressure working fluid.

Essentially, the first step is to collect and evaluate geologic data. Pilot wells may be drilled to collect various geologic data including core samples to verify models. Once a feasible well placement has been determined, one or more wells are drilled, then one or more casing strings are run and cemented in place. The well is designed and constructed in a manner that allows the working fluid to traverse between the wellbore and subterranean formation with the least restriction. If the lower part of the fracture is cased, it is necessary to sever the upper casing from the lower casing. There are many methods available today to perform this operation which may include techniques such as perforating, fracturing, water jetting, or others to establish a smooth fluid flow path into and out of the subterranean zone for the working fluid through the wellbore.

After the well is constructed, pressure pumping and fluid mixing equipment are moved to the location. One or more treatment schedules are injected into the target subterranean formation to artificially modify the permeability of the formation. At this time the formation can be sealed and prepared for the operation phase.

During the operation phase, a working fluid is injected down the well bore, and out into the subterranean zone. Energy is stored in the subterranean zone as high-pressure fluid. Fluid is pumped from a low-pressure storage area to a high-pressure subterranean zone where it can be used immediately or stored for a period of time before being moved to the surface to produce useful work. The high-pressure fluid can, for example, be used with a turbine/generator set to produce electricity. Low-pressure storage can be a subterranean zone located close to the surface. One or more wells might be used in the subterranean energy storage system. Some may be dedicated to injection or production flow, or a combination of these regimes depending on subterranean zone access and system demands. In any event, the fluid is stored there under pressure until all, or part of the fluid volume is returned to the surface. In most instances, this high-pressure fluid will be used to produce electricity. The output could be used to power a data center, an industrial plant, a manufacturing center, a food processing plant or some other medium to large scale facility needing energy.

A device and a method are needed to determine the energy and fluid capacity of the subterranean zone at any point in time. The energy level is directly proportional to the volume and pressure of the fluid stored. This fluid volume is expressed as either the percent full or the percent empty. It is needed to optimize and predict the operational characteristics of the energy storage system. A measurement method is needed as input into an algorithm to determine injection or discharge duration, rate, and pressure. The width of the fracture can be useful in determining the amount of fluid and energy stored at any given point of time.

During the well construction phase if a single casing string is used, it will be necessary to cut a complete 360-degree section severing the upper casing from the lower casing. There are many methods available today to perform this operation. Existing methods include: A) a Holte Manufacturing rotating wheel; B) a Welltec bladed casing cutter; C) sand blasting with a nozzle; D) laser cutting, Foro Energy; E) rotating sawblade cutter, Baker Hughes MPC; and F) radial torch cutter, MCR Oil Tools and others.

Retractable arm well bore calipers can be used to measure dimensions in the well and open hole sections. The distance measurement between the two points in the casing string is needed in one or both of the phases described above. A temporary completion string may be installed in the well before the fracturing treatments are placed. The distance measurement can be used in the algorithm being developed to predict the fracture treatment size, fracture direction, and subterranean zone fluid capacity. In the operation phase the distance between two points in the upper casing and lower casing is needed to determine the remaining fluid capacity at different points in time during the beginning, middle and near the end of the fluid pressure discharge cycle of the subterranean zone. If the distance from a point on the upper casing to a second point on the lower casing can be measured, this data can be used to feed the algorithm which calculates the energy storage level of the subterranean zone.

There are numerous ways to measure the distance between two points in a well bore. For example, electrical resistance or linear encoders have been used, although they are not deemed accurate for a very fine resolution. Indeed, the accuracy and precision required narrow the most common measurement techniques down to two. The first is a linear variable differential transformer (LVDT) and the second is an interferometer. Both of these techniques are readily available, but will require packaging, components, and sub-system compatibility to allow them to be placed in a well bore environment and anchored near the ends of a cut in the casing.

LVDT are used in industrial applications to measure position. They contain a moving core inside three coiled windings through which an electrical current passes. As the core moves relative to the windings, the flux changes, and the voltage changes relative to the core's movement. The device is nearly frictionless, has very low hysteresis, and can be used to measure very small changes in position with low power usage.

A laser interferometer works by merging sources of light to create an interference pattern that can be analyzed to determine size, position, roughness, or depth. This technology can be used on the factory floor to measure surface roughness and surface profiles for features such as seal surfaces of machined parts. On the factory floor interferometers are used to measure surface roughness and surface profiles for features such as seal surfaces of machined parts. Interferometers can be used to measure distances as small as fractions of a nanometer. This type of technology might be used in the downhole distance measurement tool.

The present disclosure addresses and fulfills these needs left by the current state of the art. Accordingly, it is a general object of this disclosure to provide a measurement instrument and method to determine the distance between two points in the well.

It is another general object of this disclosure to use the distance between points to determine the amount of fluid stored in a well.

It is yet another general object of this disclosure to provide a subterranean energy system that uses the measured distance between points to determine the amount of energy stored in a subterranean zone.

These and other objects, features and advantages of this disclosure will be clearly understood through consideration of the following detailed description.

### SUMMARY OF THE INVENTION

According to an embodiment of the present disclosure, there is provided a method of measuring a width of a fracture created in a subterranean zone including selecting a first point along said fracture and selecting a second point along the fracture opposite the first point, installing a measuring device within the zone and measuring a distance between the two points.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified schematic view of a subterranean energy storage system with a casing cut and two packers.

FIG. 2 is a simplified schematic top view of a fracture width measurement tool.

FIG. 3 is a simplified schematic view of the cross section of a fracture width measurement tool installed in a well with a cut in the casing.

FIG. 4 is a simplified schematic view of the cross section of a fracture width measurement tool installed in a well with an open hole section.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

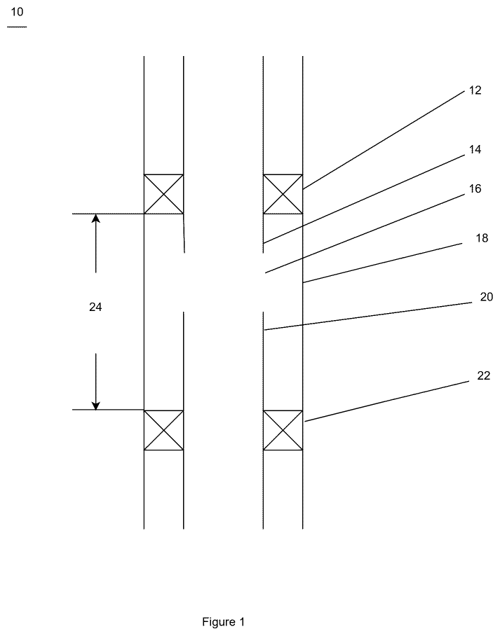

A typical well section of a subterranean energy storage system 10 is illustrated in the simplified schematic diagram of FIG. 1. It includes an upper packer 12, an upper casing 14, a cut in the casing 16, the open hole/rock face 18, the lower casing 20, the lower packer 22, and the distance to be measured 24. The upper point and the lower point do not have to be packers, but they need to be fixed to the casing sections or open hole sections that move relative to one another during fluid inspection or fluid extraction.

It is important to note that the well bore can be vertical, near vertical, horizontal, near horizontal or at any angle. Likewise, the fracture opening or the subterranean zone can be vertical, near vertical, horizontal, near horizontal or at any angle relative to the well bore.

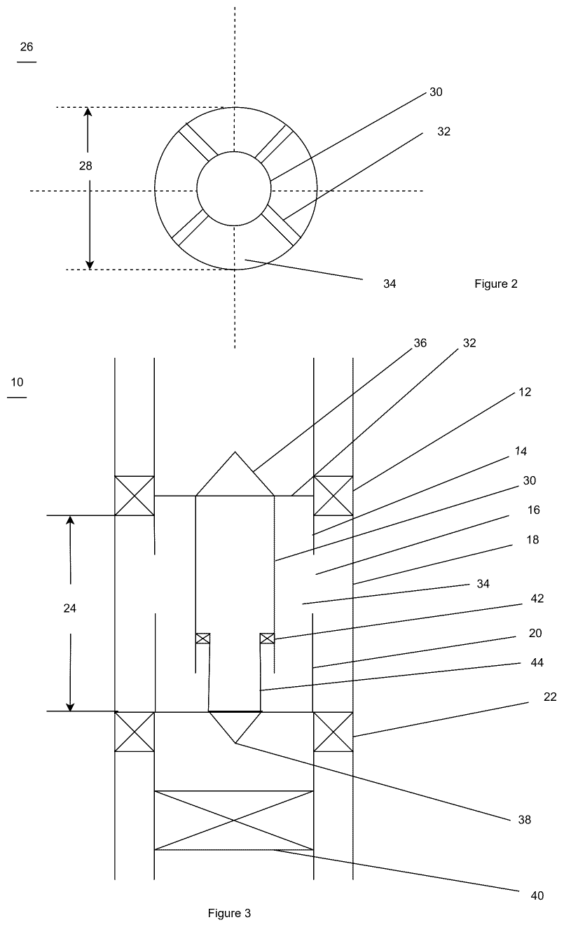

FIG. 2 shows the top view schematic of the down hole measurement tool 26. The outer diameter 28 of the tool 26, the housing 30, the cage links 32, and the axial flow area 34. It is important to note that the tool components will be curved or shaped to optimize fluid flow reducing negative features like fluid friction.

A linear measurement between two known points on an upper casing section and a lower casing section is needed to predict fracture growth, the fluid capacity of the subterranean reservoir, and the remaining fluid volume of the subterranean reservoir as the working fluid is either injected into or withdrawn from the reservoir and returned to the surface. In most instances the working fluid will be used to generate electricity.

A laser measuring device, or an interferometer might be used in either the fracturing phase or in the operation phase to measure the distance between two points located near the well bore and the opening of the subterranean zone. On the factory floor interferometers are used to measure surface roughness and surface profiles for features such as seal surfaces of machined parts. Interferometers can be used to measure distances as small as fractions of a nanometer. This type of technology might be used in the disclosed downhole distance measurement tool.

Different versions with different materials, pressure ratings, even an embodiment without seals might be used in different phases of the construction or operation of the energy storage system 10. A very robust design with no seals could be utilized for a short duration during the construction phase while the fracturing operation is being performed.

It is envisioned that the new device will house a power source, electronic circuit, memory, and the other components needed to make the distance measurement in one assembly. In some instances, it might be advantages to run a wireless, memory type tool. Other designs include a wire which is run from the surface to the down hole tool. Either version wired, or wireless could be used in the fracturing phase or the operation phase.

For the permanent completion that will be placed in the operation phase, a wire or cable assembly can be run inside or outside of the casing string to power and or communicate with the downhole device being used to measure the distance between the two points downhole.

In the construction phase there may or may not be a measurement device installed while pumping the fracturing schedule.

A measurement device might be installed, the distance measured, then removed. This set of steps might be used to optimize the fluid flow path through the well and into the subterranean zone, minimizing fluid restrictions and fluid friction. After the fracturing treatment the measurement device could be installed again and used during the operations phase. The difference between the two measurements could be used in the calculation, algorithm and/or software system to assist in the characterization of the fluid volume and energy storage capacities.

Two different devices might be used at two different times. One device might be used during the construction phase in and during the fracture treatment. It might be removed, and a second measurement device might be installed with the completion needed for the cyclic operation phase when working fluid will be cycled into and out of the subterranean zone. Alternatively, two or more measurement devices might be used at the same time during any of these phases for redundancy.

A memory type tool might be installed with the completion and interrogated occasionally to retrieve data. This might be done with conventional well intervention tools like slick line, electric wireline, or coiled tubing. Alternative designs allow for the memory type measurement tool to be installed like gas lift mandrels in a side pocket mandrel.

A permanently installed measurement tool might have a cable attached. It will run from the tool placed in the well bore to the surface. It could be used for power transmission, communication and data transfer. Glass to metal, pressure containing electrical contacts, down-hole wet connect, electrical contacts, and similar technology exist today and may be used in some configurations.

The fracture width measurement as disclosed herein may also be used to gather data about the condition of the fracture, the fluid stored and the energy stored in different kinds of rocks under any conditions. As such, these methods maybe useful for energy storage, hydrocarbon production, carbon capture, waste storage, formation subsidence, or any other down hole activity.

One or more measurement devices might be temporarily installed long enough to take a measurement and then removed to make the largest, smoothest, flow path for the working fluid during the operation phase. Installation and removal tasks can be done with conventional well intervention tools like slick line, electric wireline, pipe trips or coiled tubing. Alternative designs allow for the memory type measurement tool to be installed like gas lift mandrels in a side pocket mandrel.

Essentially, the device and method described herein measures the width of the fracture in a subterranean zone located near two points in the well at any point in time, during any phase of the fluid injection, fluid production or energy storage operation. The width measurement can be across any two points in the well. The first point and the second point may or may not be on the same type of substrate, rock, equipment, casing, pipe or tool. Indeed, the two points might be in any combinations thereof. By way of example, point one may be on the end of a casing and point two may be open hole rock face, an open hole packer, a plug, a cement plug, etc.

FIG. 3 shows the system 10 and the tool 26. The system 10 includes an upper packer 12, an upper casing 14, a cut in the casing 16, the open hole 18, the lower casing 20, the lower packer 22, and the distance to be measured 24, The tool 26 includes a, housing 30, links 32, flow area 34, top cap 36, bottom cap 38, plug 40, seal 42, and the bottom housing 44.

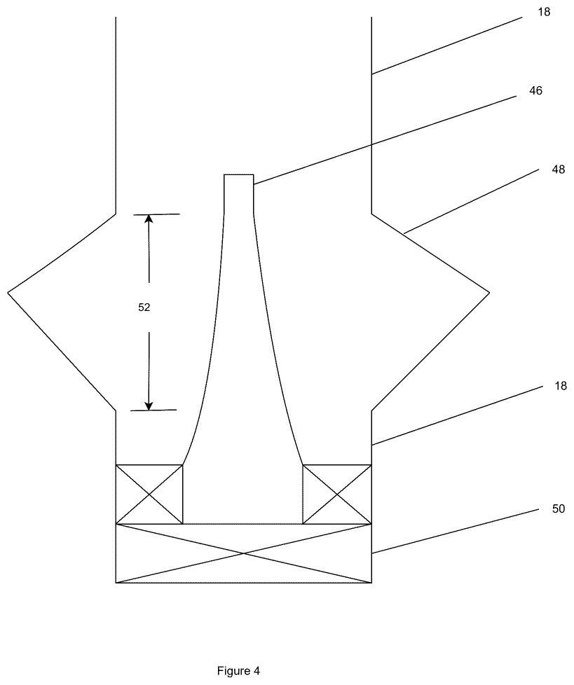

FIG. 4 shows the open hole (rock face) 18, the lower tool 46, the subterranean zone 48, the cement 50, and the distance 52.

The measurement device(s) might be installed between two packers, one of which might be set and/or anchored in the lower casing section and the other might be set and/or anchored in the upper casing section.

Alternatively, the lower packer might be a bridge plug which also plugs the lower casing. There are many different ways to design the completion, the anchoring to the casing and the attachment points for the top and bottom of the measurement device. The attachment might be to the open hole, if no casing is installed. Other examples include: open hole packers, plugs, locks, lock and nipple combinations, inflatable packers, mechanical set packers, mechanical open hole packers, hydraulic set packers, and casing patches.

It will also be appreciated that the casing may be above an open hole section. The bottom of the well may have a plug or an open hole packer. The upper point may be located at the end of the casing or tubing and the lower end may be an open hole packer or plug. As the fracture opening changes the measurement changes.

Using two measurement tools will allow for two different distance measurements to be taken at any point in time. This redundant feature might be desirable. The use of robust, proven, dynamic seal designs between the upper housing and lower housing of the measurement assembly will prevent fluid ingress.

Alternate embodiments for this down hole distance measuring tool might contain additional features. For example, (i) a cage to maximize flow area around the housing and optional cable; (ii) a clamp system for the cable to surface; (iii) encapsulated and/or armored cable run from the surface to the down hole tool; (iv) dynamic seals between the upper and lower portions of the measurement tool; (v) if the inductor style tool is used the dynamic seal might be eliminated; and (vi) a fluid guide, with gentle sloping, or curved surfaces to direct fluid flow from the well bore to the subterranean zone.

The downhole distance measurement can also be used in conjunction with a surface, downhole, or downhole differential pressure measurement to accurately assess the performance of the fractures in the subterranean energy storage zone. The additional insight from having both of these measurements (especially downhole pressure, and downhole differential pressure [tubing/casing to annulus]) include understanding of dynamic behavior of the lens and the fluid, proper operating conditions of the fractures, condition-based maintenance, initial lens quality, and changes in lens behavior due to controlled and uncontrolled variables.

Turning back to FIG. 3, the top cap 36, bottom cap 38, upper housing 14, seals 42, and lower housing 44 will protect an LVDT from well fluids, working fluid, and fluid additives. The top end will be anchored to the upper casing and the lower section will be anchored to the lower casing. The distance between the casing will change as fluid is pumped into and out of the subterranean reservoir.

A bellows might be the ultimate mechanism to seal the upper and lower parts which are dynamic and can move relative to one another. The bellows could be very robust, with a very high-pressure rating and a long service life if it were made from metal such as stainless steel, nickel alloy or another corrosion resistant material. Alternative methods to seal the bellows to the machined upper and lower parts including press fits, snap fits, elastomers, spring loaded lip seals, O-rings and the like. If the pressure rating and service life are not too extreme, then the bellows might be made of an elastomer material.

It will be appreciated that this device might be oval shaped, foil shaped or some other smooth shape to reduce fluid effects like friction. The housing might be centered in the well bore or it may be off center. The component parts and or the assembly will be designed using techniques learned from other down hole tools. They might be a round cross section, oval shaped, foil shaped or some other smooth shape to maximize fluid flow and reduce fluid friction effects. Components might be made of steel or another erosion resistant material. Some of the components which are subjected to high velocity fluid flow might be coated or, be made of hardened steel, tool steel, ceramic materials, or metals made with powdered metallurgy techniques.

One or more tools are used to measure the distance between two points in a well. This data is captured and sent immediately to the surface or an onboard memory device for later download. The distance data is one of many inputs into an algorithm used to calculate the amount of fluid stored in the subterranean zone. The amount of fluid is directly proportional to the amount of energy stored and the storage system's ability to perform useful work. The energy stored in the system varies over time as fluid is pumped into the subterranean zone or removed from the zone to perform useful work. In some formations the fluid leaks to the surrounding rock and this fluid and energy loss must be monitored as it reduces the amount of useful work that can be recovered. The amount of energy stored and the system's capability predict the amount of useful work that can be performed or the amount of electricity that can be generated are important features to predict financial performance and the ability to feed the electrical grid.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

1. (canceled)

2. A method of measuring a width of a fracture in a subterranean zone, the method consisting of:
selecting a first point along said fracture;
selecting a second point along said fracture whereby said second point is on an opposite side of said fracture than said first point;
installing a measuring device within said zone;
filling said zone with a fluid to be stored; and
measuring a distance between said first and said second point.

3. (canceled)

4. (canceled)

5. The method as defined in claim 2 wherein one of said points is a section of casing.

6. The method as defined in claim 2 wherein one of said points is a section of open hole rock.

7. The method as defined in claim 2 wherein one of said points is a plug.

8. The method as defined in claim 2 wherein one of said points is a packer.

9. The method as defined in claim 2 wherein said device is a LVDT.

10. The method as defined in claim 2 wherein said device is an interferometer.

11. The method as defined in claim 2 whereby said measuring occurs during fracturing of said zone.

12. The method as defined in claim 2 whereby said measuring occurs during operating of said zone.

13. The method as defined in claim 2 whereby said distance is used to predict a fracture size.

14. The method as defined in claim 2 whereby said distance is used to predict a fracture growth direction.

15. The method as defined in claim 2 further consisting of calculating a total zone fluid capacity from at least said distance.

16. The method as defined in claim 2 further consisting of calculating a zone fluid loss from at least said distance.

17. The method as defined in claim 2 further consisting of calculating an amount of stored energy in said zone from at least said distance.

18. The method as defined in claim 2 further consisting of calculating an amount of energy available in said zone to perform useful work.
